(19) United States
(12) Patent Application Publication
(10) Pub. No.: US 2023/0303400 A1
(43) Pub. Date: Sep. 28, 2023

(54) Method For Manufacturing Ammonium Sulphate And Calcium Carbonate From Phosphogypsum

(71) Applicants: OCP SA, Casablanca (MA); Universite Mohamed VI Polytechnique, Benguerir (MA)

(72) Inventors: Hicham Hassoune, El Jadida (MA); Adil Lachehab, El Jadida (MA); Rachid Boulif, El Jadida (MA)

(73) Assignees: OCP SA, Casablanca (MA); Universite Mohamed VI Polytechnique, Benguerir (MA)

(21) Appl. No.: 18/018,702

(22) PCT Filed: Jul. 28, 2021
(86) PCT No.: PCT/MA2021/000016

§ 371 Date: Jan. 30, 2023

(30) Foreign Application Priority Data
Jul. 31, 2020 (FR) 2008203

(51) Int. Cl. C01C 1/244; C01F 11/18; B01J 8/08

(52) U.S. Cl. CPC C01C 1/244; C01F 11/181; B01J 8/085; B01J 2208/00849; B01J 2208/00911

(57) ABSTRACT

The invention relates to a method for manufacturing ammonium sulphate and calcium carbonate from phosphogypsum, characterised in that it comprises the following steps: —dispersing phosphogypsum in water to form a phosphogypsum liquid suspension, —sparging gaseous carbon dioxide and gaseous ammonia in the phosphogypsum liquid suspension to precipitate calcium carbonate, —filtering the phosphogypsum liquid suspension to produce a filtrate comprising ammonium sulphate, and a solid residue comprising the calcium carbonate precipitate, —evaporating the filtrate to produce ammonium sulphate and drying the solid residue to produce calcium carbonate.

### FIELD OF THE INVENTION

The present invention relates to a method for manufacturing ammonium sulphate and calcium carbonate from phosphogypsum.

### STATE OF THE ART

The manufacture of phosphoric acid is carried out by sulfuric acid attack of natural phosphate, known as wet sulfuric acid attack, according to the following reaction:

(Ca₃(PO₄)₂)₃CaF₂+10H₂SO₄+20H₂O→6H₃PO₄+10(CaSO₄,2H₂O)+2HF (1)

The production of phosphoric acid results, as shown in reaction (1), by the production of considerable amounts of phosphogypsum CaSO₄, 2H₂O, which is a reaction co-product.

Various methods have been developed to convert phosphogypsum into useful and economical products by chemical means, namely calcium hydroxide, sodium sulfate, calcium carbonate and ammonium sulfate.

Ammonium sulphate is the most interesting product. It is a chemical compound with the formula (NH₄)₂SO₄. It is an ammonium (NH₄⁺) and sulfuric acid (H₂SO₄) salt which can be used in numerous applications. It is used in particular as a fertilizer intended for the acidification of alkaline soils, and contains 21% nitrogen in the form of ammonium (NH₄+) and 24% sulfur in the form of sulphate SO₄²⁻.

The synthesis of ammonium sulphate from phosphogypsum has been the subject of several studies.

The Mereseberg method, for example, described in document DE 201211002890, consists of manufacturing ammonium sulphate and calcium carbonate from phosphogypsum, ammonium carbonate and carbon dioxide. The yields of ammonium sulphate and calcium carbonate are however relatively low.

Document WO 2016186527 describes a method for manufacturing ammonium sulphate and calcium carbonate from phosphogypsum involving the Mereseberg method. The phosphogypsum is treated with sulfuric acid, in order to obtain a liquid phase containing lanthanides as well as metal phosphates and sulphates, and a solid phase in the form of sediments comprising mainly calcium sulphate. The liquid phase metals are precipitated, and the calcium sulphate sediments are treated according to the Mereseberg method. More specifically, an aqueous solution of ammonia is first added to the calcium sulphate sediments in a hot reactor. Then, carbon dioxide gas is diffused into the reactor. The method described has the same disadvantages of relatively low yields of ammonium sulphate and calcium carbonate related to the implementation of the Mereseberg method, and is furthermore long and complex to carry out.

### DESCRIPTION OF THE INVENTION

The object of the invention is therefore to overcome the disadvantages of the prior art, in particular to propose a method for manufacturing ammonium sulphate and calcium carbonate from phosphogypsum at high yield, and in which the ammonium sulphate and calcium carbonate obtained have an increased purity compared to known methods.

To this end, the invention relates to a method for manufacturing ammonium sulphate and calcium carbonate from phosphogypsum, mainly characterized in that it comprises the following steps:
dispersing phosphogypsum in water,
sparging a mixture of gaseous ammonia and gaseous carbon dioxide in the phosphogypsum liquid suspension to precipitate calcium carbonate and obtain a solution of ammonium sulphate,
filtering the phosphogypsum liquid suspension to produce a filtrate comprising ammonium sulphate, and a solid residue comprising the calcium carbonate precipitate,
evaporating the filtrate to obtain ammonium sulphate and drying the solid residue to obtain calcium carbonate.

The synthesis of ammonium sulphate (NH₄)₂SO₄ and of calcium carbonate CaCO₃ is carried out from phosphogypsum CaSO₄, 2H₂O and a gas mixture of CO₂ and NH₃. This method is therefore of particular importance in view of the considerable amounts of phosphogypsum generated by the chemical phosphate industry as well as the emissions of ammonia and carbon dioxide into the atmosphere.

This method is ecologically clean, since it simultaneously satisfies three environmental requirements, namely the recovery of phosphogypsum and the elimination of two atmospheric pollutants: carbon dioxide and ammonia.

This method further allows to manufacture two products with high added value, namely ammonium sulphate and calcium carbonate, with high yields, of the order of 90% to 95% for ammonium sulphate, and 80% to 85% for calcium carbonate).

In accordance with the invention, the phosphogypsum in liquid suspension reacts with a mixture of ammonia and carbon dioxide to obtain ammonium sulphate as the main product and calcium carbonate as the secondary product of the reaction. Gas ammonia and gas carbon dioxide are simultaneously sparged through the phosphogypsum liquid suspension. This mixture of gases ensures that the phosphogypsum dissolved in water has a high basicity, which allows better carbonation.

More specifically, the gaseous ammonia increases the basicity of the phosphogypsum liquid suspension and allows a better dispersion of the phosphogypsum in water, which improves the almost simultaneous carbonation of the phosphogypsum by carbon dioxide. The conversion of the phosphogypsum as well as the yield of the reaction are therefore improved compared to the known methods.

As the phosphogypsum undergoes the alkaline effect of ammonia, it carbonates under the effect of carbon dioxide to form a liquid phase, formed after evaporation by transparent white salts of ammonium sulphate, and a solid phase, consisting essentially of calcium carbonate after filtration.

According to other aspects, the proposed method has the following different features taken alone or according to their technically possible combinations:
gaseous carbon dioxide and gaseous ammonia are mixed in a mixer before being introduced simultaneously into the phosphogypsum liquid suspension. This allows to homogenize the mixture of gases and to send them to the phosphogypsum liquid suspension at exactly the same time, which improves the reaction;
the mixture of gaseous ammonia and gaseous carbon dioxide is introduced into the phosphogypsum liquid suspension at a flowrate comprised between 0.5 L/min and 1.5 L/min;
the drying of the calcium carbonate precipitate is carried out at a temperature comprised between 30° C. and 80° C., preferably between 50° C. and 70° C.;
phosphogypsum is obtained from the attack of natural phosphate by sulfuric acid.

The invention also relates to a chemical installation for carrying out a method for manufacturing ammonium sulphate and calcium carbonate from phosphogypsum as described above, comprising:
a reactor configured to contain a phosphogypsum liquid suspension,
injection means for injecting the mixture of gaseous ammonia and gaseous carbon dioxide into the reactor.

The chemical installation is mainly characterized in that it further comprises sparging means arranged in the reactor to cause the mixture of gaseous ammonia and gaseous carbon dioxide to circulate through the phosphogypsum liquid suspension.

According to a preferred embodiment, the sparging means comprise trapping means for trapping the gas mixture after having passed through the phosphogypsum liquid suspension.

### BRIEF DESCRIPTION OF THE FIGURES

Other advantages and features of the invention will appear upon reading the following description given by way of illustrative and non-limiting example, with reference to the appended figures in which:

FIG. 1 is a block diagram of an embodiment of the method for manufacturing ammonium sulphate and calcium carbonate of the invention, in which the phosphogypsum liquid suspension is in a reactor, and the gaseous ammonia and gaseous carbon dioxide are mixed in a mixer before being introduced simultaneously into the reactor;

FIG. 2 shows another diagram of the method for manufacturing ammonium sulphate and calcium carbonate of the invention;

FIG. 3 is a graph representing the evolution of the pH as a function of the reaction time during the manufacture of ammonium sulphate and calcium carbonate according to the invention;

FIG. 4 is a graph of a thermogravimetric analysis of calcium carbonate obtained by the method of the invention;

FIG. 5 shows an X-ray diffraction spectrum of ammonium sulfate obtained by the method of the invention;

FIG. 6 shows an X-ray diffraction spectrum of calcium carbonate obtained by the method of the invention;

FIG. 7 shows an infrared analysis spectrum of ammonium sulphate obtained by the method of the invention;

FIG. 8 shows an infrared analysis spectrum of calcium carbonate obtained by the method of the invention.

### DETAILED DESCRIPTION OF EMBODIMENTS

According to a first of the method for manufacturing ammonium sulfate and calcium carbonate from phosphogypsum, phosphogypsum CaSO₄, 2H₂O is first dispersed in water in order to obtain a phosphogypsum liquid suspension.

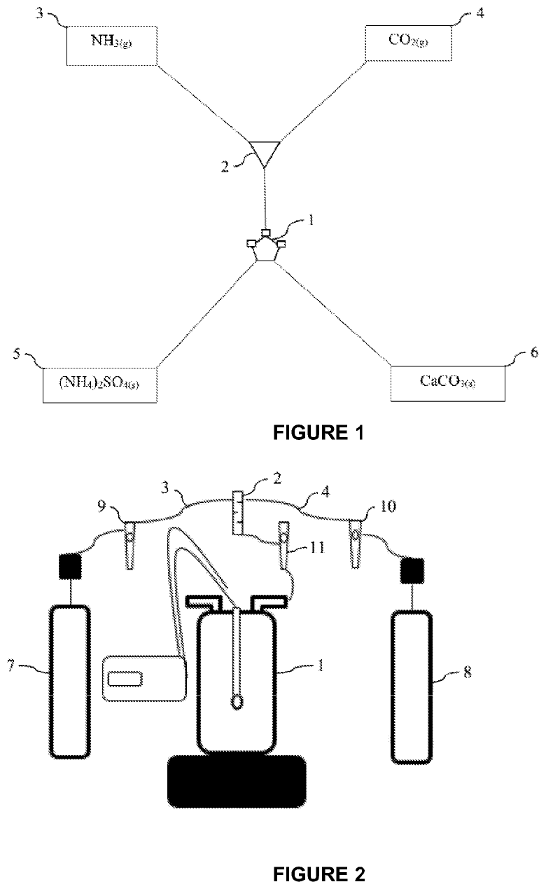

With reference to FIGS. 1 and 2, the phosphogypsum liquid suspension is in a reactor 1. In practice, the phosphogypsum is first placed in the reactor, and water is added to the reactor to disperse the phosphogypsum.

The reactor 1 is connected at the inlet to a gas mixer 2, which receives a stream of gaseous ammonia 3 and a stream of gaseous carbon dioxide 4, in which the ammonia and the carbon dioxide are mixed. The gaseous ammonia and the gaseous carbon dioxide come from tanks 7 and 8, connected to the mixer 2 via valves 9, 10 authorizing or prohibiting the supply of gases to the mixer 2. A third valve 11 is also provided between the mixer 2 and the reactor 1.

After the mixing step, the mixture of ammonia and carbon dioxide is introduced into the reactor 1, and reacts with the dispersed phosphogypsum.

This step, called “sparging”, corresponds to the passage of gaseous ammonia and gaseous carbon dioxide through the phosphogypsum liquid suspension, which results in the introduction of gas bubbles into the suspension.

The simultaneous sparging of ammonia and carbon dioxide allows these two gases to react almost simultaneously with the phosphogypsum. Indeed, the ammonia increases the basicity of the phosphogypsum liquid suspension and allows a better dispersion of phosphogypsum in water, which improves the carbonation of phosphogypsum by the carbon dioxide which takes place at the same time as the basification of the liquid suspension with ammonia.

The introduction of the mixture of ammonia and carbon dioxide into the reactor and the sparging are carried out continuously throughout the reaction of the gas mixture with the phosphogypsum liquid suspension.

Preferably, the mixture of gaseous ammonia and gaseous carbon dioxide is introduced into the phosphogypsum liquid suspension at a flowrate comprised between 0.5 L/min and 1.5 L/min.

The method of the invention is simple to implement. Indeed, the circulation of gases in the reactor simply requires providing the reactor with a sparger allowing the passage of the gas mixture through the liquid suspension and the trapping of the gas mixture after passage. On the other hand, using carbon dioxide in its liquid form would be more complex to implement and would require suitable industrial equipment allowing to apply temperature and pressure conditions in which the carbon dioxide is maintained in the liquid state when carrying out the method.

Also, since ammonia and carbon dioxide are both in the form of gases, they do not govern with each other before the reaction. This is because liquid ammonia reacts with carbon dioxide which partially dissolves in water. The reaction between liquid ammonia, carbon dioxide and water produces ammonium carbonate (NH₄)₂CO₃, in accordance with the reaction (2):

2NH₃+H₂O+CO₂→(NH₄)₂CO₃ (2)

In the method of the invention, the reaction (2) occurs only once the gas mixture is in contact with the phosphogypsum liquid suspension, and not before.

The method involves the following reactions:

CaSO₄,2H₂O+2NH₃+CO₂→(NH₄)₂SO₄+CaCO₃+H₂O (3)

CaSO₄,2H₂O+(NH₄)₂SO₄→(NH₄)₂SO₄+CaCO₃+H₂O (4)

CaSO₄,2H₂O+2NH₄HCO₃→(NH₄)₂SO₄+CaCO₃+H₂O (5)

The previous reaction (2) explains the presence of ammonium carbonate (NH₄)₂CO₃ as a reagent in the reaction (4), and the presence of ammonium bicarbonate NH₄HCO₃ as a reagent in the reaction (5) obtained by additional reaction of ammonium carbonate (NH₄)₂CO₃ with carbon dioxide and water.

After sparging, the phosphogypsum liquid suspension is filtered. The filtrate comprises ammonium sulphate 5 in the form of transparent white salts. The solid residue comprises the calcium carbonate precipitate 6.

The filtrate is evaporated to obtain ammonium sulphate.

The solid residue is dried to obtain dry calcium carbonate. Preferably, the drying of the calcium carbonate precipitate is carried out at a temperature comprised between 30° C. and 80° C., and more preferably between 50° C. and 70° C.

The calcium carbonate obtained has a purity comprised between 30% and 50% for an ammonia and carbon dioxide flowrate of approximately 1 L/min, and comprised between 60% and 85% for an ammonia and carbon dioxide flowrate of approximately 1.5 L/min.

The ammonium sulphate obtained has a purity comprised between 40% and 60% for an ammonia and carbon dioxide flowrate of approximately 1 L/min, and comprised between 60% and 85% for an ammonia and carbon dioxide flowrate of approximately 1.5 L/min.

### EXAMPLES

Examples of the manufacture of ammonium sulphate and calcium carbonate from phosphogypsum will now be described.

### Example 1: Manufacture of Ammonium Sulphate and Calcium Carbonate by Delayed Introduction of Gaseous Ammonia and Gaseous Carbon Dioxide into the Reactor, at Medium Gas Flowrate and Medium Basification

A reactor is supplied with a stream of gaseous ammonia NH₃ alone with a flowrate of 1.1 L/min for 15 min with constant stirring until the pH stabilizes at a value of 9.31. The ammonia supply is stopped. The reactor is then supplied with a stream of carbon dioxide CO₂ alone with a flowrate of 1.1 L/min until the pH stabilizes at a value of 6.24, for about 1 h 30.

At the end of the reaction, vacuum filtration is carried out, recovering two phases including a solid phase and a liquid phase. After evaporation of the liquid phase, transparent white salts of ammonium sulphate are obtained, and a by-product of calcium carbonate is identified after drying the solid phase at 60° C.

### Example 2: Manufacture of Ammonium Sulphate and Calcium Carbonate in Accordance with the Invention, by Simultaneous Introduction of Gaseous Ammonia and Gaseous Carbon Dioxide into the Reactor, at Medium Gas Flowrate and Medium Basification

The test is carried out under the same conditions as example 1, except that the reactor is supplied simultaneously with gaseous NH₃ and gaseous CO₂, in the form of a mixture of these two gases. The gas mixture is injected into the reactor with a flowrate of 1.1 L/min after having been mixed in a gas mixer. At the end of the reaction, vacuum filtration is carried out, recovering two phases including a solid phase and a liquid phase. After evaporation of the liquid phase, transparent white salts of ammonium sulphate are obtained, and a by-product of calcium carbonate is identified after drying the solid phase at 60° C.

### Example 3: Manufacture of Ammonium Sulphate and Calcium Carbonate by Delayed Introduction of Gaseous Ammonia and Gaseous Carbon Dioxide into the Reactor, at High Gas Flowrate and Strong Basification

A reactor is supplied with a stream of gaseous ammonia NH₃ alone with a flowrate of 1.4 L/min for 15 min with constant stirring until the pH stabilizes at a value of 11.73. The ammonia supply is stopped. The reactor is then supplied with a stream of carbon dioxide CO₂ alone with a flowrate of 1.4 L/min until the pH stabilizes at a value of 7.99, for about 1 h 30.

At the end of the reaction, vacuum filtration is carried out, recovering two phases including a solid phase and a liquid phase. After evaporation of the liquid phase, transparent white salts of ammonium sulphate are obtained, and a by-product of calcium carbonate is identified after drying the solid phase at 60° C.

### Example 4: Manufacture of Ammonium Sulphate and Calcium Carbonate in Accordance with the Invention, by Simultaneous Introduction of Gaseous Ammonia and Gaseous Carbon Dioxide into the Reactor, at High Gas Flowrate and Strong Basification

The test is carried out under the same conditions as example 3, except that the reactor is supplied simultaneously with gaseous NH₃ and gaseous CO₂, in the form of a mixture of these two gases. The gas mixture is injected into the reactor with a flowrate of 1.4 L/min after having been mixed in a gas mixer. At the end of the reaction, vacuum filtration is carried out, recovering two phases including a solid phase and a liquid phase. After evaporation of the liquid phase, transparent white salts of ammonium sulphate are obtained, and a by-product of calcium carbonate is identified after drying the solid phase at 60° C.

For Examples 1 and 2, the calcium carbonate obtained has a purity comprised between 30% and 50%, and the ammonium sulphate obtained has a purity comprised between 40% and 60%.

For Examples 3 and 4, the calcium carbonate obtained has a purity comprised between 60% and 85%, and the ammonium sulphate obtained has a purity comprised between 60% and 85%.

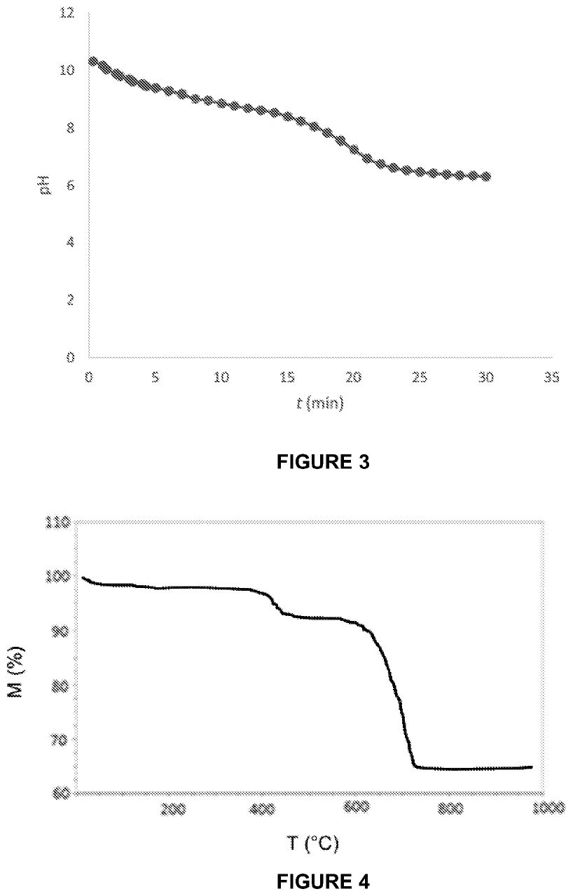

The method according to the invention comprising the simultaneous injection of ammonia and carbon dioxide gases (examples 2 and 4) results in:
faster carbonation kinetics, approximately equal to 30 minutes, compared to known methods where the ammonia and carbon dioxide gases are introduced one after the other into the reactor, and whose carbonation kinetics is approximately equal to 1 hour in the case of the use of ammoniacal water as a source of alkalinity for the dispersion of phosphogypsum, and
higher conversion rates (over 85% for ammonia and over 90% for carbon dioxide). This is reflected in FIG. 3 which represents the evolution of the pH of the reaction medium as a function of the reaction time. The pH, initially equal to 10, decreases sharply to a value of 6 for a reaction time of 30 minutes. The drop in pH corresponds to the acidification of the phosphogypsum liquid suspension by carbon dioxide.

The calcium carbonate obtained for examples 2 and 4 was analyzed by thermogravimetric analysis. The graph obtained showing the evolution of the mass M (%) of calcium carbonate as a function of the temperature T (° C.) is shown in FIG. 4. The mass of calcium carbonate drops when the temperature reaches 600° C., representing a mass loss of approximately 35%. This mass loss corresponds to the decomposition of calcium carbonate CaCO₃ into calcium oxide CaO and carbon dioxide CO₂ according to the following reaction:

CaCO₃→CaO+CO₂

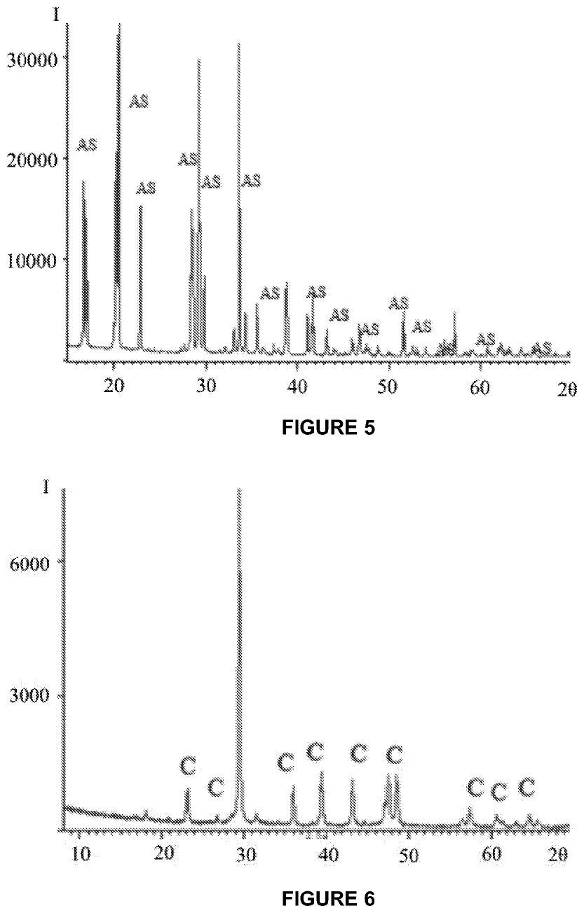

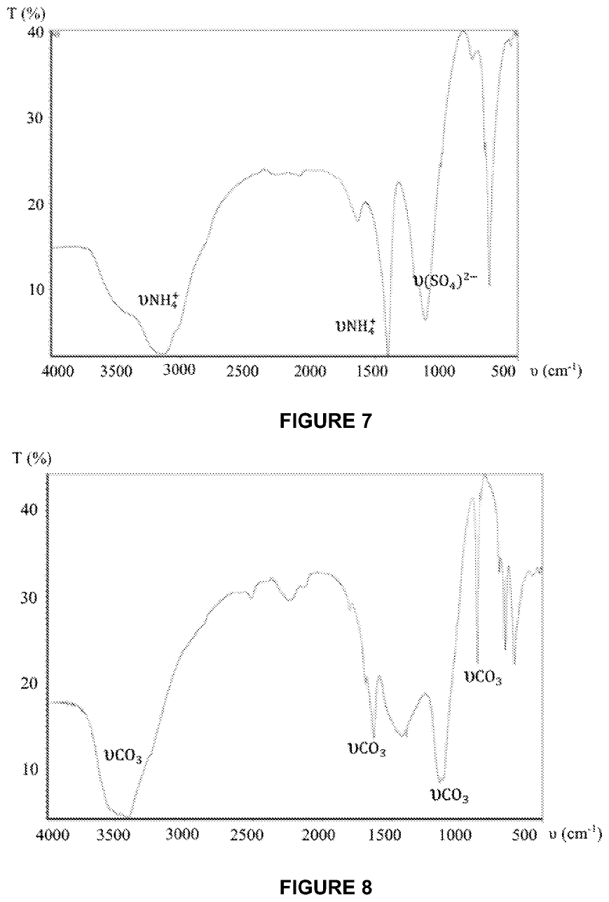

The X-ray diffraction spectra of ammonium sulphate (denoted AS) and calcium carbonate (denoted C) obtained in examples 2 and 4 are shown in FIGS. 5 and 6 respectively, and the infrared analysis spectra of sulphate ammonium and calcium carbonate obtained in examples 2 and 4 are shown in FIGS. 7 and 8 respectively.

Table 1 below indicates the amounts of the various chemical elements present in the ammonium sulphate obtained by examples 2 and 4, measured by inductively coupled plasma optical emission spectroscopy. Sulfur S and nitrogen N are obviously very predominant, and the other elements initially present in the phosphate ore are found in small amounts or even in the form of traces.

TABLE 1

| Elements | Contents | Units |
|---|---|---|
| Mg | 409.9 | ppm |
| Al | 0.2 | % |
| Si | 0.3 | % |
| P | 0.4 | % |
| S | 23.8 | % |
| N | 40 | % |
| K | 0.1 | % |
| Ca | 0.5 | % |
| Fe | 367.8 | ppm |
| Ni | 129.9 | ppm |
| Cu | 0.5 | % |
| Zn | 0.1 | % |
| Sr | 19.2 | ppm |
| Y | 51.1 | ppm |
| Ag | 932.9 | ppm |
| Sn | 23.5 | ppm |
| Yb | 30.1 | ppm |

### REFERENCES

DE 201211002890
WO 2016186527

1. A method for manufacturing ammonium sulphate and calcium carbonate from phosphogypsum, characterized in that it comprises the following steps:
dispersing phosphogypsum in water to form a phosphogypsum liquid suspension,
sparging a mixture of gaseous ammonia and gaseous carbon dioxide in the phosphogypsum liquid suspension to precipitate calcium carbonate, the gaseous carbon dioxide and the gaseous ammonia being mixed in a mixer before being introduced simultaneously into the phosphogypsum liquid suspension,
filtering the phosphogypsum liquid suspension to produce a filtrate comprising ammonium sulphate, and a solid residue comprising the calcium carbonate precipitate,
evaporating the filtrate to obtain ammonium sulphate and drying the solid residue to obtain calcium carbonate.

2. The method according to claim 1, wherein the mixture of gaseous ammonia and gaseous carbon dioxide is introduced into the phosphogypsum liquid suspension at a flowrate comprised between 0.5 L/min and 1.5 L/min.

3. The method according to claim 1, wherein the drying of the calcium carbonate precipitate is carried out at a temperature comprised between 30° C. and 80° C., preferably between 50° C. and 70° C.

4. The method according to claim 1, wherein the phosphogypsum is obtained from the an attack of natural phosphate by sulfuric acid.

5. A chemical installation for carrying out a method for manufacturing ammonium sulphate and calcium carbonate from phosphogypsum according to claim 1, comprising:
a reactor configured to contain a phosphogypsum liquid suspension,
a mixer for mixing gaseous ammonia and gaseous carbon dioxide,
injection means for injecting the mixture of gaseous ammonia and gaseous carbon dioxide from the mixer into the reactor,
the chemical installation being characterized in that it further comprises sparging means arranged in the reactor to cause the mixture of gaseous ammonia and gaseous carbon dioxide to circulate through the phosphogypsum liquid suspension.

6. The chemical installation according to claim 5, wherein the sparging means comprise trapping means for trapping the gas mixture after having passed through the phosphogypsum liquid suspension.
